(19) United States
(12) Patent Application Publication
(10) Pub. No.: US 2007/0231441 A1
(43) Pub. Date: Oct. 4, 2007

(54) Edible film having improved sealing properties

(75) Inventors: Andrew P. Verrall, Crown Point, IN (US); Stephen D. Goodrich, St. John, IN (US); Solomon E. Brown, Hobart, IN (US)

Correspondence Address: MARSHALL, GERSTEIN & BORUN LLP, 233 S. WACKER DRIVE, SUITE 6300, SEARS TOWER, CHICAGO, IL, 60606, US

(73) Assignee: MONOSOL, LLC, Merrillville, IN (US)

(21) Appl. No.: 11/392,416

(22) Filed: Mar. 29, 2006

(51) Int. Cl. A23L 1/05

(52) U.S. Cl. 426/573

(57) ABSTRACT

An edible film useful for packaging food additives is disclosed. The film generally includes an edible film-forming resin, a plasticizer, a compatibilizer, and optional secondary additives. The resulting edible film has favorable heat seal properties, being able to form an acceptable heat seal over temperature ranges of at least about 10° C.

### BACKGROUND

1. Field of the Disclosure

The disclosure relates to an edible film composition generally used for packaging food additives. More particularly, the disclosure relates to an edible film including an edible film-forming resin, a plasticizer, and a compatibilizer, wherein the edible film has a heat seal temperature range of at least about 10° C.

2. Brief Description of Related Technology

Edible, water-soluble films are intended for use in the food and baking industries for packaging unit doses of a food ingredient. This arrangement facilitates food production by allowing the unit dose of food ingredient (including the packaging film) to be added directly to a mixing operation without the need for opening and disposing of the packaging film.

While the use of edible films reduces the number of steps in a production process and eliminates waste output, current edible films have limitations in the process of packaging the individual items. Typically, the packaging process utilizes a single piece of machinery to shape the edible film into a package, to fill the package with a food ingredient, and then to seal the package by applying heated surfaces to the open edge(s) of the package. However, conventional edible films create difficulties in forming an acceptable heat seal over a wide temperature range.

### SUMMARY

One aspect of the disclosure provides an edible film composition including a film-forming resin, a plasticizer, and a compatibilizer, wherein a film formed from the composition has a heat seal temperature range of at least about 10° C. Another aspect of the disclosure provides an edible film composition including methylhydroxypropyl cellulose, glycerin, lactic acid, adipic acid, polyethylene glycol, and polysorbate. A third aspect of the disclosure provides a unit-dose, pre-packaged food item including a food item contained in a heat sealed package formed from an edible film composition disclosed herein.

Further aspects and advantages will be apparent to those of ordinary skill in the art from a review of the following detailed description. While the method and articles are susceptible of embodiments in various forms, the description hereafter includes specific embodiments with the understanding that the disclosure is illustrative, and is not intended to limit the invention to the specific embodiments described herein.

### DETAILED DESCRIPTION

Conventional edible films present difficulties in forming an acceptable heat seal over a sufficiently wide temperature range to accommodate variable ambient and intra-film properties. In particular, small changes in the film moisture content can shift the narrow temperature range over which the edible film will form an acceptable seal so that the range does not encompass the set-point of a heat sealing machine. When this happens, the film-seal bonding is very poor, resulting in a either a weak, even peelable seal, or an overheated, even burned seal.

The compositions described herein are useful for forming edible films that can be used as packages for ingredients such as foodstuffs, and articles made from such films. As used herein, the term “edible film composition” can refer to both the composition itself and a film formed from the composition. The compositions generally comprise an edible film-forming resin, a plasticizer, a compatibilizer, and optional additives. The resulting films are also characterized by relatively wide heat sealing temperature ranges.

Unless specified otherwise, the composition concentrations disclosed herein are given on a dry weight basis of the total weight of the components (wt. %). The dry weight for the determination of the concentration includes the weight of the edible film-forming resin, plasticizers, compatibilizers, and optional secondary additives, but excludes the weight of any solvents (e.g., water).

Edible Film-Forming Resin

The preferable edible film-forming resins of the disclosure are safely ingestible by humans in the amounts used, and/or are preferably cold-water soluble, and/or preferably have a 2% solution viscosity at 20° C. of about 15 cP to about 50 cP. A suitable edible film-forming resin is methylhydroxypropyl cellulose (“MHPC”).

The concentration of the edible film-forming resin is preferably at least about 30 wt. %, more preferably at least about 40 wt. %, and most preferably at least about 55 wt. %. The concentration of the edible film-forming resin is preferably not more than about 85 wt. %, more preferably not more than about 70 wt. %, and most preferably not more than about 65 wt. %. Alternatively, the concentration of the edible film-forming resin is preferably in a range of about 30 wt. % to about 85 wt. %, more preferably about 40 wt. % to about 70 wt. %, and most preferably about 55 wt. % to about 65 wt. %.

When the edible film-forming resin is MHPC, it is not particularly limited as to molecular weight, the degree of substitution of methoxyl groups, and the molar substitution of hydroxypropyl groups. However, for ease of film processing, the MHPC preferably has a 2% solution viscosity at 20° C. of about 15 cP to about 50 cP, which corresponds to an approximate weight-average molecular weight of about 60,000 Da to 87,000 Da. Suitable commercial grades of MHPC include METOLOSE SE-50 MHPC (available from Shin-Etsu Chemical Co. Ltd.), and METHOCEL E-15FG MHPC and METHOCEL E-50FG MHPC (available from Dow Chemical Company).

Blends of polymer gums can be used as the edible film-forming resin. Preferably, the resulting blend will have a 2% solution viscosity at 20° C. of about 15 cP to about 50 cP.

Additives

The edible film composition includes at least one edible plasticizer. The plasticizer permeates the polymer structure, disrupts intermolecular hydrogen bonding, and permanently lowers intermolecular attractions. When incorporated into the composition, the plasticizer serves to lower the glass transition temperature of the resulting film and therefore lowers the heat sealing temperature. Plasticizers that may be used include, but are not limited to: glycerin; low-molecular weight polyethylene glycol (e.g., having a liquid consistency, for example having and a molecular weight such as MW 200, MW 300, and MW 600); monoacetin; triacetin; triethyl citrate; sorbitol; 1,3-butanediol; D-glucono-1,5-lactone; and, propylene glycol.

The concentration of all plasticizers is preferably at least about 5 wt. %, and more preferably at least about 8 wt. %. The concentration of all plasticizers is preferably not more than about 40 wt. %, more preferably not more than about 30 wt. %, and most preferably not more than about 20 wt. %. The concentration of all plasticizers in the edible film composition can be in a range of about 5 wt. % to about 40 wt. %, more preferably about 5 wt. % to about 30 wt. %, and most preferably about 8 wt. % to about 20 wt. %.

The edible film composition also includes at least one edible compatibilizer. The compatibilizer serves to create enhanced plasticization of the edible film-forming resin, thereby improving the heat seal temperature range of the edible film. Without intending to be bound by any particular theory, it is believed that the resin-compatibilizer system disclosed carboxyl-ether hydrogen bonds. These attachments can be viewed as a form of non-covalent polymeric alloying. Suitable compatibilizers include, but are not limited to: lactic acid, adipic acid, high-molecular weight polyethylene glycol (e.g., having a solid or at least pasty consistency, for example having a molecular weight of at least about 1000, including MW 3350 and MW 8000 as specific examples), and polysorbate (e.g., polysorbate 60). More generally, other carboxylic acids, polyethers, carboxymethyl starch, starch (including modified and native, unmodified), and carboxymethyl cellulose are contemplated for use as compatibilizers. A suitable compatibilizing modified starch includes the modified corn starch PURE-COTE B760 (available from Grain Processing Corporation, Muscatine, Iowa).

Some components perform both plasticizing and compatibilizing functions. Examples of such components include lactic acid, adipic acid, polyethylene glycol, and polysorbate. Each of these components is believed to have compatibilizer functionality because, although most effective as a multicomponent compatibilizer blend with glycerin, each component when combined singly with glycerin increases the heat seal temperature range as compared to the use of glycerin as the sole additive to the edible film composition.

The concentration of all compatibilizers is preferably at least about 8 wt. %, more preferably at least about 10 wt. %, and most preferably at least about 12 wt. %. The concentration of all compatibilizers is preferably not more than about 65 wt. %, more preferably not more than about 40 wt. %, and most preferably not more than about 25 wt. %. Alternatively, the concentration of all compatibilizers combined in the edible film composition is in a range of about 8 wt. % to about 65 wt. %, more preferably about 10 wt. % to about 40 wt. %, and most preferably about 12 wt. % to about 25 wt. %.

A preferred mixture of plasticizers and compatibilizers includes glycerin and at least two members selected from the group consisting of lactic acid, adipic acid, high-molecular weight polyethylene glycol, polysorbate, and starch, more preferably at least three members of the group.

Most preferably, all members of the group consisting of lactic acid, adipic acid, high-molecular weight polyethylene glycol, polysorbate, and starch are in the mixture. In this embodiment, the concentration of glycerin is in a range of about 5 wt. % to about 40 wt. % (preferably about 5 wt. % to about 30 wt. %, and more preferably about 8 wt. % to about 20 wt. %), the concentration of lactic acid is in a range of about 5 wt. % to about 30 wt. % (preferably about 5 wt. % to about 20 wt. %, and more preferably about 8 wt. % to about 12 wt. %), the concentration of adipic acid is in a range of about I wt. % to about 12 wt. % (preferably about I wt. % to about 7 wt. %, and more preferably about 2 wt. % to about 5 wt. %), the concentration of high-molecular weight polyethylene glycol is in a range of about 0.5 wt. % to about 10 wt. % (preferably about 0.5 wt. % to about 5 wt. %, and more preferably about 1 wt. % to about 3 wt. %), the concentration of polysorbate is in a range of about I wt. % to about 15 wt. % (preferably about 2 wt. % to about 10 wt. %, and more preferably about 2 wt. % to about 6 wt. %), and the concentration of starch is in a range of about 0.5 wt. % to about 15 wt. % (preferably about 1 wt. % to about 12 wt. %, and more preferably about 1.5 wt. % to about 10 wt. %). The foregoing concentrations for each ingredient are contemplated for use independently and in combination with the concentrations described for the remaining plasticizers and compatibilizers, the total preferably falling in a range of about 15 wt. % to about 70 wt. %.

The edible film composition may optionally include secondary additives such as extenders, lubricants, surfactants, and anti-blocking agents. Any secondary additives should be ingestible by humans in the amounts used. The secondary additives may be included at any concentrations that do not materially affect the heat seal temperature range of the resulting film. Concentrations typically known and used in the art of water-soluble films are contemplated for use.

Edible Film-Forming Composition

The edible film preferably is prepared by the solution casting of an aqueous mixture (e.g., solution) of the edible film-forming resin, plasticizers, co mpatibilizers, and any secondary additives. The preferred weight ratio of the amount the edible film-forming resin as compared to the combined amount of all plasticizers and compatibilizers is preferably in a range of about 0.4 to about 5, more preferably about 1 to about 3, and most preferably about 1.5 to 2.5., The resulting film can have any suitable thickness, for example in a range of about 40 μm to about 50 μm.

The process of heat sealing a package made from a film is generally known in the art. During one type of packaging process, the edible film is shaped into a package, the package is filled with a food ingredient, and then the package is heat sealed. The heat seal is typically effected by exposing open, opposing sides of the film around the periphery of the package to heated surfaces under pressure for a specified dwell time. The temperatures over which an effective heat seal is formed define the heat seal temperature range.

Conventional edible films have used MHPC as an edible film-forming resin However, these edible films have heat seal temperature ranges of less than 10° C., which is prohibitively narrow given normal process and ambient variations.

The heat seal temperature range of the present disclosure is advantageously at least about 10° C., preferably at least about 12° C., more preferably at least about 15° C., and most preferably at least about 20° C. The heat seal temperature range has no practical upper bound, as increasing ranges only make for easier heat seal processing. The range is contemplated to reach about 35° C. or about 30° C. Alternatively, the heat seal temperature range is advantageously in a range of about 10° C. to about 30° C., about 10° C. to about 22.5° C., or about 12° C. to about 22.5° C.

Various embodiments of the edible film composition described herein can optionally yield one or more advantages. For example, the composition described herein can provide a film which is convenient to shape and fill with food ingredients, thereby streamlining and reducing waste in batch food processing operations. Suitable food ingredients include bread improvers, food dyes, enzymes, vitamins, yeasts, conditioners, and cold drink mixes. The film is also heat sealable over a wide range of temperatures, which can allow for high-speed, commercial production in a food packaging operation by reducing or eliminating the need to adjust the temperature set-point of the heat sealer. The film is water-soluble and ingestible by humans (in the amounts used relative to the food ingredient).

Method for the Determination of the Heat Seal Temperature Range

An edible film according to the present disclosure forms a seal when open areas around the periphery of a package (e.g., two opposing film layers that provide access to the package prior to sealing) are exposed to a heated surface under pressure for a specified amount of time. A given film is characterized by a range of temperatures over which an acceptable heat seal forms. Below the lower limit of this heat seal temperature range, the temperature is too low to resiliently seal the opening, resulting in a seal that may be easily peeled apart. Above the upper limit of this heat seal temperature range, the temperature is hot enough to burn the sealed portion of the package, resulting in a brittle, fragile seal that may be easily broken. The precise temperatures at which an acceptable heat seal forms depends on factors including the moisture content of the edible film.

The heat seal characteristics of different edible films can be objectively compared by the following method.

An edible film to be tested is first allowed to reach its equilibrium temperature and moisture content in a 23° C. air atmosphere at 50% relative humidity. These conditions are arbitrary, and are selected to approximate the median ambient environment experienced by an edible film during typical packaging processes. After equilibration, two opposing surfaces of the edible film are contacted by a heated surface at a fixed temperature under a pressure of 60 psi. The heated surface remains in contact with the two opposing surfaces of the edible film for a dwell time of 1 second. A suitable heat sealing device for this procedure is the Model TS-12 Heat Sealer, available from Lako Tool and Manufacturing, Inc.

To determine the heat seal temperature range for a specific edible film composition, multiple samples of the specific edible film composition are analyzed over a range of temperature set-points for the heat sealing device. Typically, the samples are analyzed at temperature set-points varying in increments of about 0.5° C., although larger increments may be used when trying to roughly approximate the boundaries of the heat seal temperature range. For each sample analyzed, the resulting sealed film is inspected to determine the quality of the heat seal. If the resulting seal is weak and may be easily peeled apart, then the tested set-point temperature is below the heat seal temperature range. If the resulting seal appears burned or frosty and may be easily fractured apart, then the tested set-point temperature is above the heat seal temperature range. If the resulting seal does not display any of the characteristics of an unacceptable seal, then the tested set-point temperature is within the heat seal temperature range. Once a sufficiently broad range of temperature set-points has been analyzed, the upper and lower ends of the heat seal temperature range for the edible film are determined. Multiple replicates are preferably performed at each temperature for accuracy and reproducibility, and statistical analyses may be incorporated.

### EXAMPLES

The following examples are provided for illustration and are not intended to limit the scope of the invention.

Five edible film compositions were prepared and tested to determine their respective heat seal temperature ranges. Each edible film contained about 60 wt. % to 70 wt. % MHPC having a 2% solution viscosity of 50 cP as the edible film-forming resin. For Examples 1 to 3, about 35 wt. % of the edible film included a blend of plasticizers and compatibilizers in accordance with the present disclosure. Comparative Examples 1 and 2 are representative of conventional edible films, and, therefore, the remaining weight fraction of the edible film included only plasticizers and secondary additives. All five films were prepared by blending the various components and then performing a conventional solution casting process to create a film having a thickness of about 50 μm. The specific components. concentrations, and heat seal temperature characteristics (as determined by the method described above) for each example are given in Table 1.

TABLE 1

| | | | Heat Seal Temperatures (° C.) | | |
|---|---|---|---|---|---|
| | Component | | Lower | Upper | |
| Sample | Name (wt. %) | Function | Limit | Limit | Range |
| Example 1 | MHPC (61.4) | Resin | 157 | 173 | 16 |
| | Glycerin (16.7) | Plasticizer | | | |
| | Lactic acid (9.6) | Compatibilizer | | | |
| | Adipic acid (3.7) | Compatibilizer | | | |
| | PEG 8000 (1.9) | Compatibilizer | | | |
| | Polysorbate 60 (4.2) | Compatibilizer | | | |
| | Secondary additives (2.5) | | | | |
| Comparative | MHPC (69.8) | Resin | 162 | 168 | 6 |
| Example 1 | Glycerin (10.4) | Plasticizer | | | |
| | Propylene glycol (18.7) | Plasticizer | | | |
| | Secondary additives (1.1) | | | | |
| Comparative | MHPC (66.4) | Resin | 168.5 | 177 | 8.5 |
| Example 2 | Monoacetin (30.6) | Plasticizer | | | |
| | Secondary additives (3.0) | | | | |
| Example 2 | MHPC (61.5) | Resin | 159 | 179.5 | 20.5 |
| | Glycerin (13.2) | Plasticizer | | | |
| | Lactic acid (9.6) | Compatibilizer | | | |
| | Adipic acid (3.7) | Compatibilizer | | | |
| | PEG 8000 (1.9) | Compatibilizer | | | |
| | Polysorbate 60 (4.2) | Compatibilizer | | | |
| | Modified corn starch (3.4) | Compatibilizer | | | |
| | Secondary additives (2.5) | | | | |
| Example 3 | MHPC (61.4) | Resin | 157 | 179.5 | 22.5 |
| | Glycerin (9.9) | Plasticizer | | | |
| | Lactic acid (9.6) | Compatibilizer | | | |
| | Adipic acid (3.7) | Compatibilizer | | | |
| | PEG 8000 (1.9) | Compatibilizer | | | |
| | Polysorbate 60 (4.2) | Compatibilizer | | | |
| | Modified corn starch (6.7) | Compatibilizer | | | |
| | Secondary additives (2.6) | | | | |

The foregoing description is given for clearness of understanding only, and no unnecessary limitations should be understood therefrom, as modifications within the scope of the invention may be apparent to those having ordinary skill in the art.

Throughout the specification, where the composition is described as including components or materials, it is contemplated that the compositions can also consist essentially of, or consist of, any combination of the recited components or materials, unless described otherwise.

1. An edible film-forming composition, comprising: a mixture of an edible film-forming resin, a plasticizer, and a compatibilizer; wherein a film formed from the composition has a heat seal temperature range of at least about 10° C.

2. The edible film-forming composition of claim 1, wherein said mixture is in the form of a film.

3. The edible film-forming composition of claim 1, wherein the heat seal temperature range is in a range of about 10° C. to about 30° C.

4. The edible film-forming composition of claim 3, wherein the heat seal temperature range is in a range of about 10° C. to about 22.5° C.

5. The edible film-forming composition of claim 1, wherein the heat seal temperature range is at least about 20° C.

6. The edible film-forming composition of claim 1, wherein:
the edible film-forming resin comprises methylhydroxypropyl cellulose;
the plasticizer comprises glycerin; and, the compatibilizer is selected from the group consisting of: lactic acid, adipic acid, polyethylene glycol, polysorbate, starch, and combinations thereof.

7. The edible film-forming composition of claim 6, wherein the compatibilizer comprises at least two members selected from the group consisting of: lactic acid, adipic acid, polyethylene glycol, polysorbate, and starch.

8. The edible film-forming composition of claim 7, wherein the compatibilizer comprises at least three members selected from the group consisting of: lactic acid, adipic acid, polyethylene glycol, polysorbate, and starch.

9. The edible film-forming composition of claim 1, wherein:
the edible film-forming resin is present in a range of about 40 wt. % to about 70 wt. %;
the plasticizer is present in a range of about 5 wt. % to about 30 wt. %; and,
the compatibilizer is present in a range of about 10 wt. % to about 40 wt. %.

10. The edible film-forming composition claim 9, wherein:
the edible film-forming resin is present in a range of about 55 wt. % to about 65 wt. %;
the plasticizer is present in a range of about 8 wt. % to about 20 wt. %; and, the compatibilizer is present in a range of about 12 wt. % to about 25 wt. %.

11. The edible film-forming composition of claim 1, wherein the weight ratio of edible film-forming resins to the sum of all plasticizers and compatibilizers is in a range of about 1.5 to about 2.5.

12. The edible film-forming composition of claim 1, further comprising a secondary additive selected from the group consisting of extenders, lubricants, surfactants, anti-blocking agents, and combinations thereof.

13. The edible film-forming composition of claim 1, wherein the edible film-forming resin has a 2% solution viscosity at 20° C. of about 15 cP to about 50 cP.

14. The edible film-forming composition of claim 1, wherein the edible film-forming resin comprises a blend of polymer gums having a 2% solution viscosity at 20° C. of about 15 cP to about 50 cP.

15. An edible film-forming composition, comprising: methylhydroxypropyl cellulose, glycerin, lactic acid, adipic acid, high-molecular weight polyethylene glycol, and polysorbate.

16. The edible film-forming composition of claim 15, consisting essentially of: methylhydroxypropyl cellulose, glycerin, lactic acid, adipic acid, high-molecular weight polyethylene glycol, and polysorbate.

17. The edible film-forming composition of claim 15, comprising:
about 40 wt. % to about 70 wt. % methylhydroxypropyl cellulose;
about 5 wt. % to about 30 wt. % glycerin;
about 5 wt. % to about 20 wt. % lactic acid;
about 1 wt. % to about 7 wt. % adipic acid;
about 0.5 wt. % to about 5 wt. % high-molecular weight polyethylene glycol; and, about 2 wt. % to about 10 wt. % polysorbate.

18. The edible film-forming composition of claim 17, comprising:
about 55 wt. % to about 65 wt. % methylhydroxypropyl cellulose;
about 8 wt. % to about 20 wt. % glycerin;
about 8 wt. % to about 12 wt. % lactic acid;
about 2 wt. % to about 5 wt. % adipic acid;
about 1 wt. % to about 3 wt. % high-molecular weight polyethylene glycol; and, about 2 wt. % to about 6 wt. % polysorbate.

19. The edible film-forming composition of claim 15, wherein the edible film-forming composition has a heat seal temperature range in a range. of about 10° C. to about 30° C.

20. The edible film-forming composition of claim 15, wherein the edible film-forming composition has a heat seal temperature range of at least about 20° C.

21. The edible film-forming composition of claim 17, further comprising about 1 wt. % to about 12 wt. % of a starch.

22. An edible film-forming composition, comprising: a film comprising a mixture of
about 55 wt. % to about 65 wt. % methylhydroxypropyl cellulose;
about 8 wt. % to about 20 wt. % glycerin;
about 8 wt. % to about 12 wt. % lactic acid;
about 2 wt. % to about 5 wt. % adipic acid;
about 1 wt. % to about 3 wt. % polyethylene glycol (MW 8000);
about 2 wt. % to about 6 wt. % polysorbate 60; and, about 1.5 wt. % to about 10 wt. % modified starch;
wherein the heat seal temperature range of the film is in a range of about 10° C. to about 30° C.

23. A unit-dose, pre-packaged food item, comprising: a food item contained in a heat-sealed film package formed from the edible film-forming composition of claim 1.
